(19) United States
(12) Patent Application Publication
(10) Pub. No.: US 2021/0053293 A1
(43) Pub. Date: Feb. 25, 2021

(54) HIGH SPEED EXTRUSION 3-D PRINTING SYSTEM

(71) Applicant: Essentium, Inc., Pflugerville, TX (US)

(72) Inventors: William J. MacNeish, III, Newport Beach, CA (US); Blake Teipel, Pflugerville, TX (US); Charles Brandon Sweeney, Pflugerville, TX (US); Erik John Gjovik, Aliso Viejo, CA (US)

(21) Appl. No.: 16/982,859

(22) PCT Filed: Mar. 20, 2019
(86) PCT No.: PCT/US19/23197

§ 371 Date: Sep. 21, 2020

Related U.S. Application Data
(60) Provisional application No. 62/646,019, filed on Mar. 21, 2018.

(51) Int. Cl. B29C 64/393; B29C 64/118; B29C 64/209; B33Y 10/00; B33Y 30/00

(52) U.S. Cl. CPC B29C 64/393; B29C 64/118; B33Y 30/00; B33Y 10/00; B29C 64/209

(57) ABSTRACT

A three-dimensional printer and a method of printing includes feeding a feedstock into a print nozzle including a heated barrel by applying a first extrusion force on the feedstock with a feed system; heating the feedstock in the heated barrel at a first temperature to melt the feedstock; and depositing the melted feedstock onto a support table, wherein the first extrusion force and first temperature are selected to provide a volumetric flow rate in the range of up to 120 cubic millimeters per second.

### CROSS-REFERENCE TO RELATED APPLICATIONS

The present disclosure claims the benefit of U.S. Provisional Application No. 62/646,019, filed on Mar. 21, 2018, the teachings of which are incorporated by reference herein.

### FIELD

The invention relates generally to a three dimensional (3D) printing system, and more particularly to a high speed extrusion 3D printing system.

### BACKGROUND

The statements in this section merely provide background information related to the present disclosure and may or may not constitute prior art.

Three-dimensional (3D) printing is an additive manufacturing process for producing 3D models, which may include prototype or production parts, directly from a digital model. Additive manufacturing is a process that takes virtual blueprints from computer aided design (CAD) or animation modeling software and slices them into digital cross-sections for the 3D printing system, including a 3D printer, for use as a guideline for printing the 3D model. Layers of composite material are successively deposited in droplets or continuous beads until the final 3D model has been printed. These layers are jointly welded, also known as fused, to create and maintain the shape of the printed 3D model.

For 3D printing systems that use an extrusion deposition process, such as Fused Filament Fabrication (FFF) and Fused Deposition Modeling (FDM), a thermoplastic composite filament is applied through a heated extrusion nozzle. One of the primary limiting factors preventing the widespread adoption of ME 3D printing technology in the industrial manufacturing sector is the slow build rate. The printer movement speed, firmware that manages the print head velocity, and the volumetric flow rate of extruded material through the printer head are factors that have an impact on the build rate. Known 3D printing systems are limited by the power that could be applied to ‘pushing’ the filament (torque at a given speed). For example, the speed of FFF/FDM printing has been limited by the ability to force a viscoelastic melted polymer through a small 0.4-2.0 mm diameter port.

It is desirable to improve the speed, accuracy, and control of a 3D printing system to increase the efficiency and productivity of printing 3D parts. Thus, while current 3D printing systems achieve their intended purpose, there is a need for a new and improved 3D printing system and a method for producing faster and more accurate 3D parts.

### SUMMARY

According to several aspects of the present disclosure, a method of printing with a 3D printer. The method includes feeding a feedstock into a barrel by applying a first extrusion force on the feedstock; heating the feedstock in the barrel at a first temperature to melt the feedstock; and depositing the melted feedstock onto a support table, wherein the first force and first temperature are selected to provide a volumetric flow rate in the range of up to 120 cubic millimeters per second.

In another aspect, the method further includes melting the feedstock in a liquefier portion of the barrel, wherein the barrel temperature is in the range of 20° C. to 600° C.

In another aspect, the feedstock is a filament and the method further comprises engaging the filament with a rotatable feed hob to feed the filament into the barrel.

In another aspect, the rotatable feed hob is mounted on a drive shaft coupled to a drive motor.

In yet another aspect, the method further includes measuring a torque applied to the drive shaft by the drive motor.

In another aspect, the torque is measured by measuring a current supplied to the drive motor.

In another aspect, the first feed rate and the first temperature are selected from a master viscosity curve, wherein the master viscosity curve is calculated from a plurality of viscosity measurements derived from sensor measurements taken at various feed rates and various barrel temperatures.

In another aspect, the sensor measurements include an extrusion force measurement, an encoder measurement, and a temperature sensor measurement.

In yet another aspect, the method further includes reducing the barrel temperature at a rate in the range of 0.1° C. per second to 60° C. per second.

In yet a further aspect, the method includes pausing or stopping deposition of the melted feedstock by reducing the first extrusion force.

According to several aspects of the present disclosure, a three-dimensional printer is provided. The printer includes a control system; a barrel including a heating element electrically coupled to the control system, wherein the control system is configured to select a barrel temperature; a feed system configured to supply feedstock to the barrel, wherein the control system is configured to select an extrusion force applied to the feedstock by the feed system; and wherein the control system is configured to select a barrel temperature and an extrusion force that provides a volumetric flow rate in the range of up to 120 cubic millimeters per second.

In additional aspects, the feed system includes a drive motor including a drive shaft; a feed hob coupled to the drive shaft and configured to engage the feedstock; a torque sensor electrically coupled to the control system configured to measure extrusion force applied by the drive motor; and an encoder electrically coupled to the control system configured to measure the drive shaft speed.

In another aspect, a temperature sensor is affixed to the barrel and coupled to the control system.

In another aspect, the control system is configured to calculate a master curve based on a plurality of viscosity measurements derived from extruding the feedstock at various feed rates, wherein the various feed rates are measured by the encoder, temperatures measured by the temperature sensor; and an extrusion force for each feed rate and temperature measured by the torque sensor.

In another aspect, the torque sensor is a current sensor configured to measure a current applied to the drive motor.

In yet another aspect, the three-dimensional printer further includes a cooling system, wherein the cooling system is configured to reduce the barrel temperature at a rate in the range of 0.1° C. to 60° C.

According to several aspects of the present disclosure a method of calibrating a three dimensional printer is provided. The method includes performing a feedstock feed rate sweep by extruding a feedstock material through a printer nozzle at various extrusion forces to achieve a range of feed rates; deriving the feedstock viscosity at each feed rate; extruding the feedstock through the printer nozzle including a barrel at various barrel temperature and at one or more feed rates; deriving the feedstock viscosity at each barrel temperature; calculating a master viscosity curve for the feedstock from the feedstock viscosity derived at each feed rate and each barrel temperature setting; and selecting a feed rate and temperature for providing a maximum build rate.

In additional aspects, each feed rate is measured by an encoder configured to measure the rotational rate of a drive shaft.

In additional aspects, each extrusion force is measured by a torque sensor associated with a drive motor coupled to the drive shaft.

In additional aspects, each barrel temperature is measured by a temperature sensor mounted to the barrel.

### BRIEF DESCRIPTION OF THE DRAWINGS

The drawings described herein are for illustration purposes only and are not intended to limit the scope of the present disclosure in any way.

FIG. 1 is a representative viscosity versus shear rate graph for shear thinning materials A and Newtonian fluids B;

FIG. 2 is a perspective view of an aspect of a three-dimensional printer head and support table of the present disclosure;

FIG. 3 is a perspective view of an aspect of a print nozzle of the present disclosure;

FIG. 4 is a cross-sectional view of the barrel of FIG. 3;

FIG. 5a is a perspective view of an aspect of a z-axis plate assembly and print nozzle of the present disclosure;

FIG. 5b is a back perspective view of a z-axis plate assembly and print nozzle of FIG. 5a;

FIG. 5c is a top perspective view of the flexures of the z-axis plate assembly of FIGS. 5a and 5b;

FIG. 6a is a side, perspective view of a portion of the feed system including an aspect of the drive motor, feed plate and feed hob;

FIG. 6b is a side, perspective view of a portion of the feed system including an aspect of the drive motor, feed plate, idle assembly and receiver;

FIG. 7a is a side, perspective view of an aspect of the feed hob of the present disclosure;

FIG. 7b is a side, perspective view of the feed hob of FIG. 7a without the face plate;

FIG. 7c is a cross-sectional view of the feed hob of FIG. 7b;

FIG. 8a is a front, perspective view of an aspect of the idle assembly of the present disclosure;

FIG. 8b is a cross-section of the idle assembly of FIG. 8a;

FIG. 9 is a front, exploded, perspective view of an aspect of the printer head of the present disclosure illustrating the cross-bar and idle assembly adjustment knob;

FIG. 10 is a rear view of an aspect of the adjustment knob of the idle assembly of the present disclosure;

FIG. 11a illustrates a cross-sectional view of an aspect of the sensor assembly of the present disclosure;

FIG. 11b illustrates an exploded view of the sensor assembly of FIG. 14a;

FIG. 12 is a cross-sectional view of the printer head of FIG. 2 illustrating an aspect of placement of a force sensor of the present disclosure;

FIG. 13 illustrates a schematic diagram of an aspect of a control system for the printer head of the present disclosure;

FIG. 14 is a schematic line drawing of a beaded extrusion;

FIG. 15 is a representative viscosity versus shear rate log graph illustrating a reduction in viscosity as shear rate increases to a region exhibiting near Newtonian flow;

FIG. 16 is a representative extrusion force versus extrusion rate graph illustrating an initial decrease and then increase in extrusion force as extrusion rate increases; and

FIG. 17 is a flow chart presenting a method of rheological characterization.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

The print speed of known Material Extrusion (ME) 3D printers, such as Fused Filament Fabrication (FFF) and Fused Deposition Modeling (FDM) printers, are limited by the rate at which a feedstock material can flow through the extruder nozzle. The rate of a feedstock material flow through the extruder nozzle is limited by the available extrusion force on the filament and heating power of the nozzle that known 3D printers can generate.

It was surprisingly discovered that the speed and accuracy of material extrusion (ME) 3D printers may be significantly increased by selecting material extrusion parameters to ensure the flow of the feedstock material is maintained at high shear rates, and thus in the shear thinning region, to enable relatively higher speed extrusion through the extruder nozzle, with extrusion rates expressed as volumetric flow rates in the range of up to 120 cubic millimeters per second (mm\hat{ }3/s), such as in the range of 1 mm\hat{ }3/s to 120 mm\hat{ }3/s, including all values and ranges therein. The selected material extrusion parameters include, but are not limited to, average shear area (could be variable with flow rate); extrusion force; flow velocity; flowing volume (could be variable with flow rate), temperature; extrusion force; and average melt temperature (variable). In aspects, the 3D printer measures these parameters using various sensors to provide closed loop control in the printing process. In further aspects, the 3D printer is also used to map and determine process windows for specific materials based on these parameters.

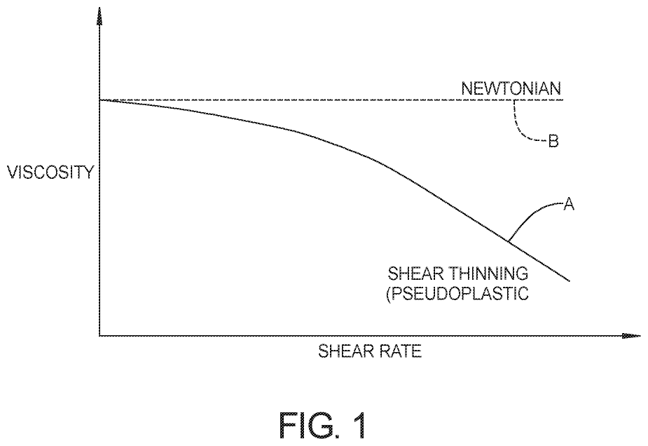

Without being bound to any particular theory, an understanding of polymer rheological behavior yields the expectation that many polymers experience shear-thinning behavior when processed at sufficiently high material flow rates, the rate depending on the specific polymer. Deformation and flow are referred to as strain and strain rate, respectively, and indicate the distance over which a body moves under the influence of an external force, or stress. Shear thinning is the non-Newtonian behavior of fluids whose viscosity decreases under shear strain. Viscosity is defined as shear stress over shear strain. Shear stress may be integrated over the printer nozzle barrel diameter in the heated region as extrusion force over some average shear area (units Pa or N/m\hat{ }2). The average shear area is the area of a cross-sectional area (offset from the nozzle interior) that is the radial location of average flow velocity. Shear strain may be integrated over the over the printer nozzle barrel diameter in the heated region as average flow velocity over the flowing volume (units 1/s). FIG. 1 shows an exemplary viscosity vs. shear rate graph, which illustrates that for shear thinning materials-A as the shear rate increases viscosity decreases, including the polymer materials typically employed in the 3D printing system. The shear thinning materials are compared to Newtonian fluids-B, which do not exhibit a change in viscosity as shear rate increases.

Disclosed herein is a 3D printing system and method in which sufficient heating rates and extrusion forces are available such that the shear thinning regime is accessible for the normal operation of a material extrusion (ME) 3D printer. To operate in the desired shear thinning regime of a given feedstock, i.e., where the feedstock exhibits a relatively low viscosity of less than 10\hat{ }4 Pa*s in the melt state such as in the range of 10\hat{ }1 Pa*s to 10\hat{ }4 Pa*s when passing through the printer nozzle 12, the 3D printer extruder runs on-line characterization sweeps over the flow-rate (shear) and temperature parameter space (i.e., characterizing the material over a range of feed rates and a range of temperatures), and the firmware (control system) is configured to print in the low-viscosity region to adjust and maximize volumetric throughput. Feedstock materials such as thermoplastics, siloxanes, resins (1- and 2-part systems), and other Non-Newtonian pseudo-plastics that exhibit shear thinning may be extruded through a constrained flow system (pipe/nozzle) under selected conditions for relatively improved throughput. The materials may be modified by additives, processing, or formulations to improve or widen the processing window in which sheer thinning is achieved.

In various aspects, the 3D printer generally includes a printer head including a heated extruder nozzle, a feed system for providing the feedstock to the nozzle, and controlling the feed rate, a support table to support the extrudate as it is being printed, and a cooling system to assist in regulating nozzle and printed component temperature. In a method of printing, a feedstock is fed into the printer head, then melted in the print nozzle, and deposited on the support table to form a three-dimensional component. In a particular aspect, as the extrudate, i.e., the melted feedstock, is deposited on the support table, the temperature of the extrudate is reduced by the cooling system, solidifying the extrudate at a relatively faster rate than without using the cooling system.

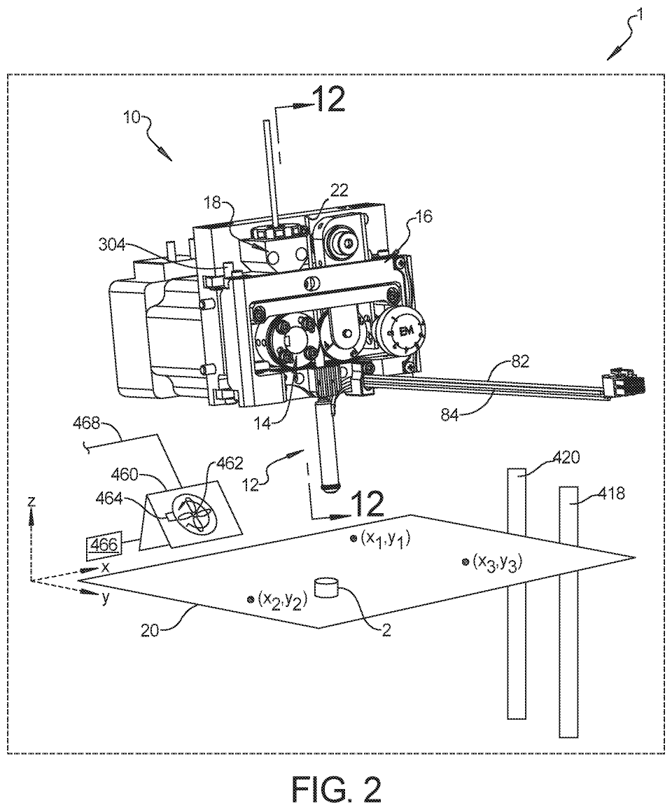

FIG. 2 illustrates a three-dimensional printer 1 including a three-dimensional printer head 10 according to several aspects of the present disclosure. The three-dimensional printer head 10 includes a print nozzle 12. As noted above, the printer head 10 also includes a feed system 14 for feeding feedstock 22, in the illustrated aspect a filament, into the print nozzle 12. The feedstock 22 includes the materials noted above; an example of which includes thermoplastic materials, or materials that are at least partially thermoplastic, such as thermoplastic co-polymers that include elastomeric blocks. Accordingly, non-limiting examples of materials include polyester, polyether ether ketone, polyethylene, thermoplastic elastomers, etc. In addition, the feedstock materials may include various modifiers that may alter the mechanical, chemical, or visco-elastic properties of the material. Alternatively, other materials, such as one- and two-part crosslinking polymers, including liquid silicone rubber or polyurethanes, may be utilized. It is also noted that the feedstocks may be provided as filament, powder, or as a liquid.

In aspects, the print nozzle 12 is mounted to a z-axis plate assembly 16, which allows the print nozzle 12 to move in the z-axis, up and down relative to the support table 20 independently of the feed system 14. Alternatively, the print nozzle 12 may be mounted to the printer head 10 in a stationary manner.

Further, a number of sensors are provided. An aspect of a sensor assembly 18 is illustrated in FIG. 2, which, in this aspect, measures the location of the print nozzle 12 relative to the support table 20. Additional sensors are also provided for monitoring of drive/extruder motor power, drive rotation speed and barrel temperature, which sensors are discussed further herein. Such sensors may also be mounted in a similar sensor assembly 18.

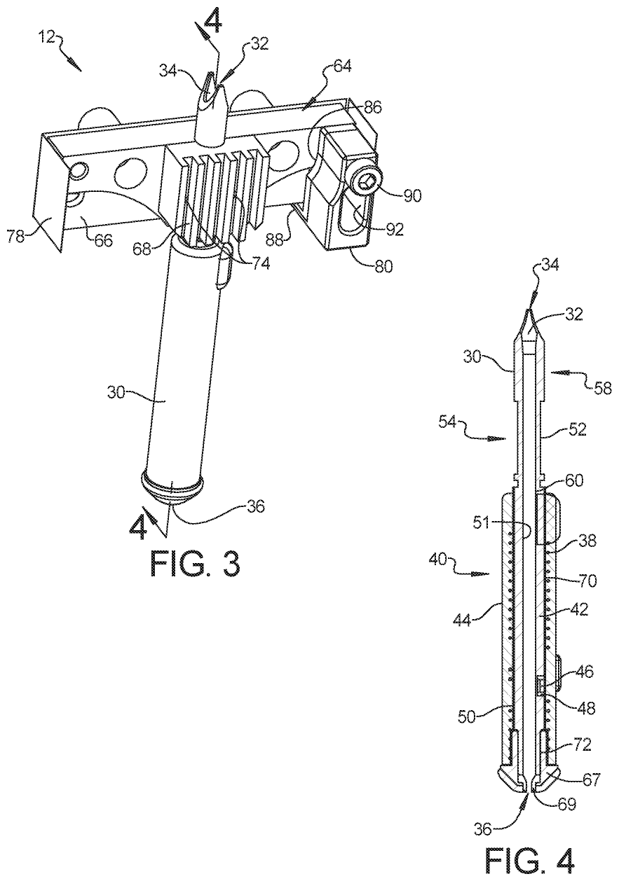

FIG. 3 illustrates a print nozzle 12. The print nozzle 12 includes a barrel 30. In aspects, a portion of the barrel 30, which is also referred to herein as the liquefier, is heated to melt filament 22 (see FIG. 2) or other feedstock that passes through an opening 32 in the barrel 30. The opening 32 extends the length of the barrel 30, from the feed end 34 to the discharge end 36 (illustrated in FIG. 3). A cross-section of the barrel 30 is illustrated in FIG. 4. The barrel 30 includes a heater coil 38 that is wrapped a number of times around a lower portion 40 of the barrel shank 42, which provides the liquefier. Additional, or alternative, heating elements and methods of heating the barrel may be employed, such as electromagnetic radiation in the infrared spectrum 300 GHz to 3 THz and microwave spectrum from 0.03 GHz to 300 GHz, induction, electric heater bands. Insulation 44 is provided around the barrel shank 42 and heater coil 38 or other heating element, which provides electrical insulation between the heater coil 38 and the barrel 30. The insulation 44 may include one or more layers of a ceramic, fiberglass or other material wrapped around, coated on, or otherwise deposited onto the barrel 30. Also provided is a temperature sensor 46, which may be mounted to the barrel 30 in a channel 48 formed in the surface 50 of the barrel shank 42, so that the sensor 46 sits close to the inner wall 51 of the barrel 30 defining the opening 32. The heating element 38 is electrically coupled to the control system 400 as illustrated in 13.

In aspects, the barrel 30 further includes a neck 52 in the upper portion 54 of the barrel 30 having a reduced diameter as compared to the regions of the barrel 58, 60 above and below the neck 52. In aspects, the neck 52 may provide a heat break to reduce the transfer of heat from the lower portion 40 of the barrel 30 to the upper portion 54 of the barrel 30. In addition, the neck 52 may help secure the print nozzle 12 in the print nozzle clamp 64 (seen in FIG. 2) and, in particular, preventing movement of the barrel 30 in the z-direction relative to the nozzle clamp 64. The barrel 30 also includes an end cap 67, which retains an end tip 69 against the discharge end 36 of the barrel 30. The exterior surface 70 of the barrel 30 proximal to the discharge end 36 exhibits, in aspects, a reduced diameter region 72 as compared to the region 60 of the barrel 30 adjacent the reduced diameter region 72.

Turning again to FIG. 3, the nozzle clamp 64 includes a clamping frame 66 and a clamp plate 68, between which the barrel 30 is retained. The clamp plate 68 is affixed to the clamping frame 66 by one or more mechanical fasteners 74, such as screws, which engage the clamp plate 68 and clamping frame 66. In addition, the clamping frame 66 is affixed to the z-axis plate assembly 16 by one or more mechanical fasteners (not illustrated). In aspects, an isolation film 78 may be place around at least three sides of the clamping frame 66 to provide electrical insulation from the barrel 30 from transferring to the z-axis plate assembly 16. The isolation film 78 may be formed from, for example, a ceramic coating deposited on the clamping plate, a fiber glass sheet, an epoxy sheet, or a sheet of other insulating material.

The print nozzle 12 also includes, in aspects, a cable clamp 80 for retaining wire leads 82, 84, illustrated in FIG. 2, electrically coupling the heater coil 38 and temperature sensor 46 to the control system 400 (see FIG. 15). A backing plate 86 may also be provided between the cable clamp 80 and the clamping frame 66. In further aspects, as illustrated, the backing plate 86 is “L” shaped, so as to provide a support shelf 88 for the wire leads 82, 84. In aspects, the cable clamp 80 and backing plate 86 is affixed to the clamping frame 66 by a mechanical fastener 90, which passes through a bore 92 in the cable clamp 80, backing plate 86, and clamping frame 66.

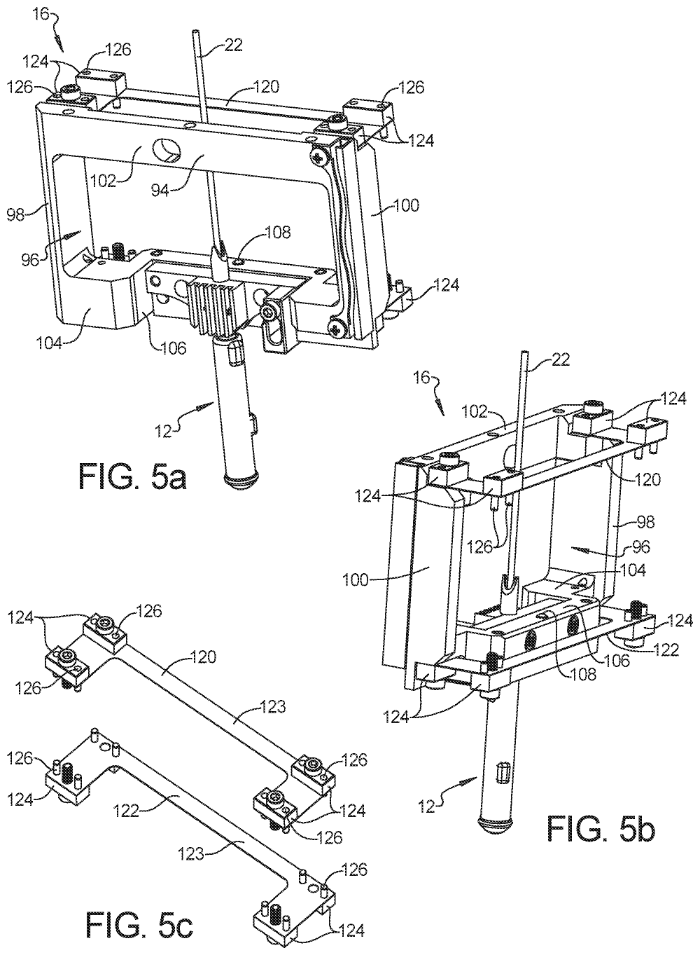

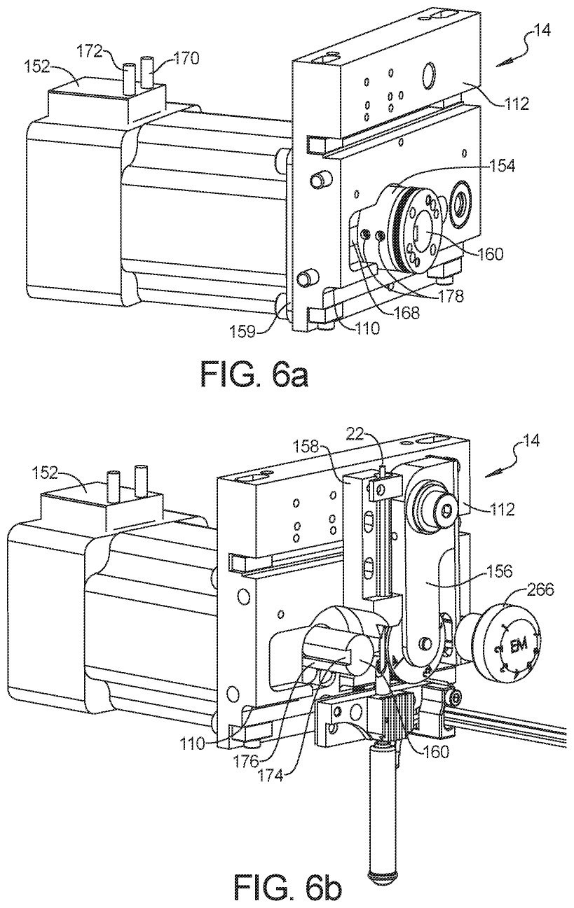

FIGS. 5a and 5b illustrate further aspects in which the print nozzle 12 mounted in a z-axis plate assembly 16. In the illustrated aspect, the z-axis plate assembly 16 includes a plate 94 that defines an opening 96 framed by opposing, first and second vertical side walls 98, 100 and opposing, first and second horizontal side walls 102, 104. The second, lower horizontal side wall 104 defines a recess 106 therein for receiving the print nozzle 12. The side wall 104 may impinges against a ledge 110 formed on the feed plate 112 as illustrated in FIGS. 6a and 6b if the z-axis plate assembly is configured to move in the z-axis.

With reference to FIG. 5a through 5c, the z-axis plate assembly 16 further includes first and second flexures 120, 122. The flexures 120, 122 are compliant members that affix the z-axis plate assembly 16 and feed plate 112, as seen in FIG. 6. In aspects, the flexures are formed from blue spring steel; however, other metals, metal alloys or polymer materials may be used. Material selection and thickness may be adjusted to tune for the desired amount of spring force. For example, in the case of blue spring steel, the flexures may exhibit a thickness in the range of 0.10 mm to 1.00 mm, including all values and ranges therein such as 0.25 mm. The flexures 120, 122 are affixed to the z-axis plate 94 and the feed plate 112 using blocks 124 (not all have been labeled for clarity) and mechanical fasteners 126 (again, a few have been labeled for clarity). The flexures 120, 122 are placed between the plates 94, 112 and the blocks 124 and the mechanical fasteners 126 affix the blocks 124 to the z-axis plate 94 and the feed plate 112.

The flexures 120, 122 are illustrated as taking on a “C” shape, however, other configurations may be assumed. Further, in the illustrated aspect, the elongated arm 123 of the “C” shape flexures 120, 122 is affixed to the feed plate 112; however, alternative arrangements are also contemplated for each flexure 120, 122. While two flexures are illustrated extending between the z-axis plate assembly 16 and the feed plate 112, three or more flexures may be provided, such as in the range of three to eight flexures. In addition, while it is illustrated that each stabilization block is fastened by at least two mechanical fasteners, e.g., screws, to the feed plate 112 and at least three mechanical fasteners, e.g., screws, to the z-axis plate assembly 16, one or more, such as up to four mechanical fasteners may be used to tie the stabilization blocks 124 to the z-axis plate assembly 16 and the feed plate 112.

As illustrated in FIG. 2, a cross-bar 140 is fixed in the opening 96 formed by the z-axis plate 94, wherein the z-axis plate 94 moves relative to the cross-bar 140 and the feed plate 112. The cross-bar 140 may be affixed using mating fasteners 142, such as a nut and bolt assembly, or via a screw which engages the feed plate 112. If the z-axis plate assembly 16 moves in the z-axis, the cross-bar 140 may limit the travel of the z-axis plate assembly 16.

With reference to FIGS. 6a and 6b, an aspect of feed system 14 is illustrated for feeding feedstock 22 in the form of filament; however, other feed systems 14 may be employed configured to feed, for example powder or liquid feedstock into the nozzle. In this aspect, the feed system 14 pulls filament 22 from a filament cart (not illustrated) or other filament supply source. Systems that feed powder or liquid into the nozzle may include augers within the barrel 30 of the print nozzle 12 to help transport the feedstock into the barrel 30.

The feed system 14 generally includes a drive motor 152, a feed hob 154 mounted to the drive motor 152, an idle assembly 156 mounted to the feed plate 112, and a receiver 158 also mounted to the feed plate 112. Turning now to FIG. 6a, in aspects, a support plate 159 is provided between the drive motor 152 and the feed plate 112. The support plate 159 may provide mechanical stabilization of the feed plate 112 the various components affixed thereto, including the feed hob 154, the idle assembly 156, the receiver 158, z-axis plate assembly 16, the print nozzle 12, and the sensor assembly 18 (described later herein).

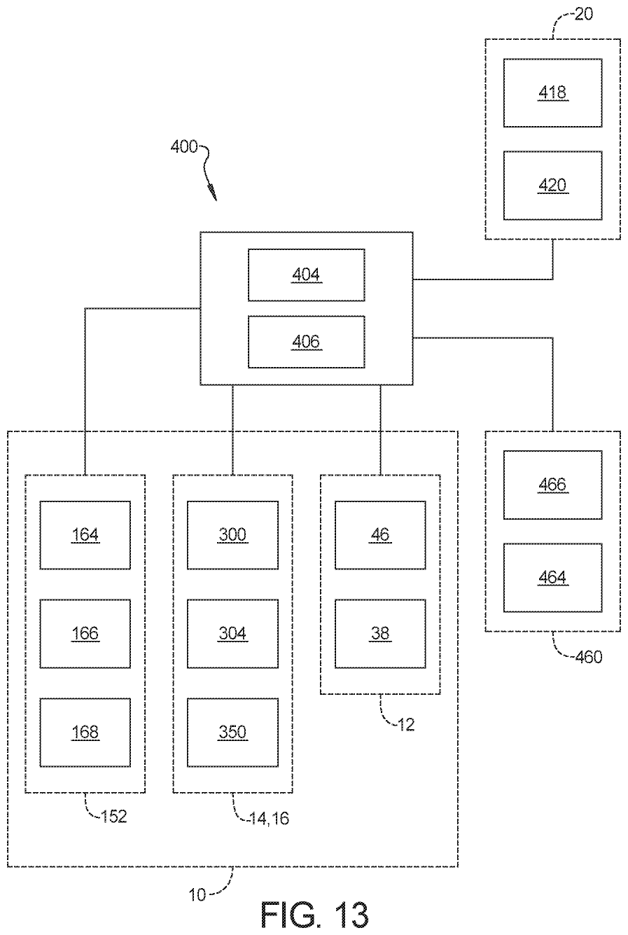

The drive motor 152 includes a drive shaft 160 extending therefrom (illustrated in FIG. 6b), which is received in the feed hob 154. In aspects, the drive motor 152 is a servo-motor. The feed hob 154 is mounted to the drive shaft 160 in a non-rotatable manner relative to the drive shaft 160, such that the feed hob 154 rotates with the drive shaft 160. In aspects, the drive motor 152 includes a number of sensors, including e.g., a current sensor (164 seen in FIG. 13), a torque sensor (166 seen in FIG. 13), or both a current sensor and a torque sensor, for measuring the extrusion force applied by the feed hob 154 to the filament 22. In aspects, the torque sensor 166 may be omitted and the current sensor 164 may be used to measure torque. In addition, an encoder (168 seen in FIGS. 6a and 13) is provided for measuring rotational speed of the drive shaft 160 or feed hob 154 from which the linear and volumetric flow rate of the filament 22 may be derived. One or more wire leads 170 electrically couple the sensors to a control system 400, illustrated in FIG. 13. Further, power is provided to the drive motor 152 via one or more wire leads 172, which in further aspects, may also be electrically coupled to the control system, illustrated in FIG. 13.

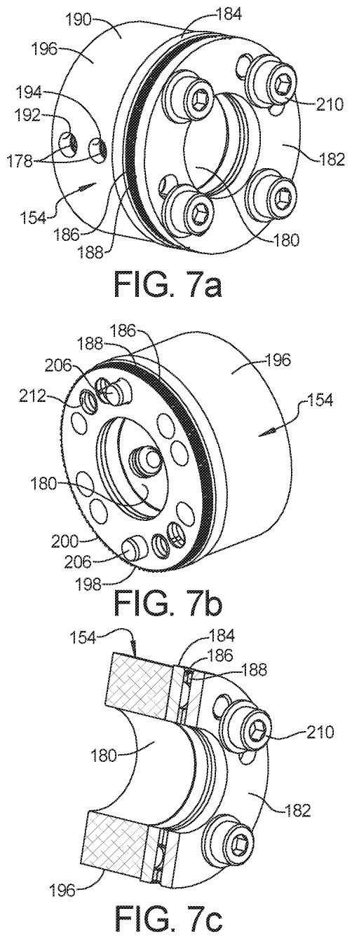

The drive shaft 160 includes a groove 174 formed in the surface 176 of the drive shaft 160, which receives one or more locking features 178 of the feed hob 154. As illustrated, the locking feature is a pair of set screws 178, which extend through the feed hob 154 into the drive shaft 160 groove 174; however, in other embodiments, the locking feature 178 may be a tooth extending from the interior surface 180 (see e.g., FIG. 7a) of the feed hob 154, or a set of dowel pins which may also extend through the feed hob 154 into the drive shaft 160 groove 174.

Reference is now made to FIGS. 7a, 7b, and 7c. The feed hob 154 includes a face plate 182, a back plate 184, drive teeth plates 186, 188, and a hob backing 190 for affixing the plates 182, 184, 186, 188 to the drive shaft 160. As alluded to above, through holes 192, 194 are provided in the hob backing 190, from the external surface 196 to the interior surface 180, in which the set screws 178 are inserted; the screws 178 engaging the hob backing 190 to the drive shaft 160. As illustrated, two drive teeth plate 186, 188 are provided, which engage the filament 22. While only two plates 186, 188 are illustrated, one to 4 drive teeth plates may be provided, depending on plate thickness and filament geometry. In particular aspects, the drive teeth plates 186, 188 include an odd number of teeth 198, which are formed into the periphery 200 of the drive teeth plates 186, 188. A number of drive teeth plates, in the range of 1 to 300 plates including all values and ranges therein, may be formed at the same time using e.g., wire electrical discharge machining (wire EDM). If an odd number of teeth are formed, the teeth 198 may be offset by placing the plates 186, 188 back to back, assuming the plates are stacked front to back when machined. In aspects, the drive teeth plates 186, 188 are 500 nm to 1 micrometer in size, including all values and ranges therein. The face plate 182, back plate 184, and drive teeth plates 186, 188 are located relative to each other and the hob backing 190 by dowel pins 206. The plates 182, 184, 186, 188 and the hob backing 190 are then secured using one or more mechanical fasteners 210, such as a nut and bolt assembly, which are inserted through bores 212 that extend through the feed hob 154 from the face plate 182 to the hob backing 190.

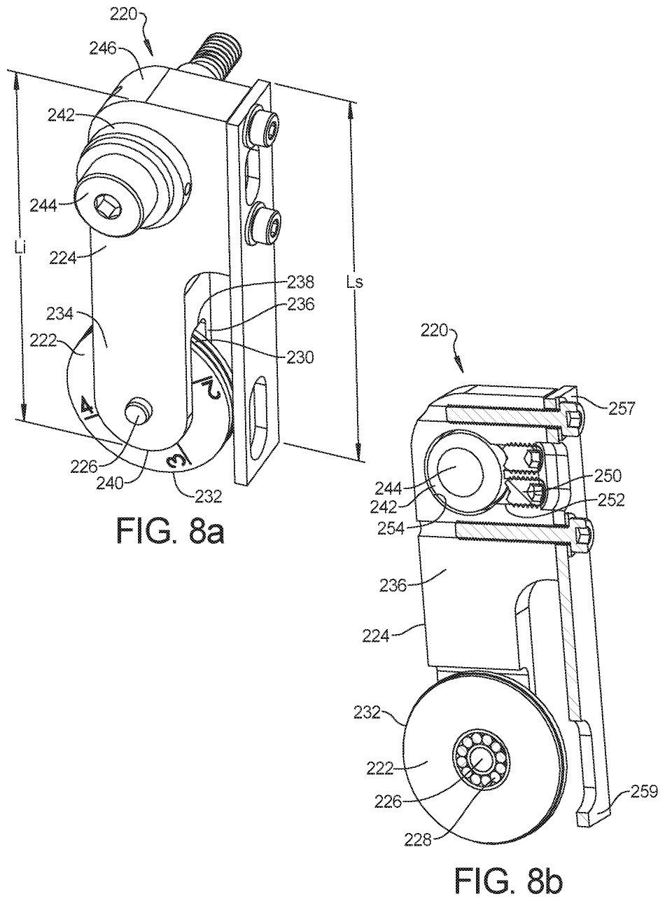

As illustrated in FIGS. 6b and 8 and 8b, when filament is used as the feedstock 22, the feed system 14 further includes an idle assembly 156. The idle assembly 156 helps to guide the filament 22 against the feed hob 154 and into the barrel 30 of the print nozzle 12. The idle assembly 156 includes an idle hob 222, which is suspended in the idle arm body 224 on a spindle 226, such that the idle hob 222 rotates around the spindle 226. In an aspect, a bearing 228 is placed on the spindle 226 and the idle hob 222 rides on the bearing 228. The bearing 228 includes, in one aspect, a ball bearing; however, alternative bearings may be employed. The idle hob 222 includes defines a channel 230 in the perimeter 232 of the idle hob 222, which may generally accommodate the geometry of many of the filaments 22 used in the printer head 10. Stated another way, the width of the channel 230 may the same size or larger than the thickness of many of the filaments 22 used in the printer head 10; however, it may be appreciated that in some instances, the filaments 22 may be larger than the channel 230. The spindle 226 is mounted in two projections 234, 236 defining a groove 238 in the idle arm body 224 proximal to a first end 240 of the idle arm body 224.

The idle arm body 224 rides on and rotates with an eccentric cam 242, which rotates around a pivot, in this case a screw 244, proximal to a second end 246, which opposes the first end 240. As the idle arm body 224 rotates around the pivot 244, the idle arm body 224 moves up and down, which moves the idle hob 222 up and down. This movement of the idle hob 222 up and down steers the filament 22 left or right. The ability to steer the filament 22 left or right assists in reducing drag caused by the filament 22 hitting the inner wall 50 of the barrel 30 at the feed end 34. Factors that may affect drag of the filament 22 include, e.g., filament 22 thickness, durometer, and flexural characteristics. A pair of set screws 250 is provided in bores 252 that extend into the idle arm body 224 through to the cam opening 254. The set screws 250 abut the eccentric cam 242.

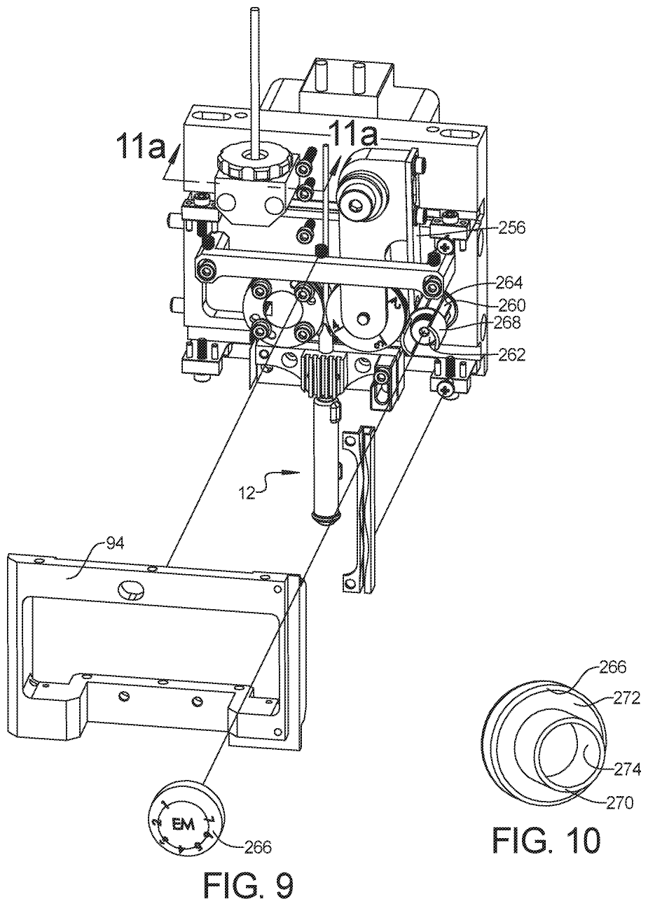

A leaf spring 256 is affixed at a first end 257 to the idle arm 204 proximal to the second end 246 of the idle arm 204. In aspects, the leaf spring 256 is affixed using one or more mechanical fasteners. The leaf spring 256 extends down to the idle hob 222 and, in particular aspects, may exhibit a length Ls that is as long as or longer than the length Li of the idle arm body 224. As illustrated in FIG. 9, the leaf spring 256 is biased at a second end 259 (noted in FIG. 8b) against a second eccentric cam 260. The second eccentric cam 260 rotates around a pivot point, in this example, a screw 262. The second cam 260 includes a number of detents 264, which contact the leaf spring 256, wherein the size of the detents 264 vary around the perimeter of the cam. In aspects, an adjustment knob 266, illustrated in FIG. 6b and FIG. 9, is used to adjust the bias applied to the leaf spring 256 by the second eccentric cam 260, wherein larger detents 264 apply a greater bias against the leaf spring 256. The adjustment knob 266 is mounted on the retention brackets 268, which extend from the second eccentric cam 260. With reference to FIG. 10, the retention brackets 268 are received in a hub 270 extending from the back 272 of the knob 266 and are biased against the internal wall 274 of the hub 270. Further, the retention brackets 268 include a mechanical feature that interlocks with the internal wall 274 of the hub 270. For example, one or both retention brackets 268 may include teeth that engage one or more grooves defined in the internal wall 274 of the hub 270. A third eccentric cam 261 is also provided. The second eccentric cam 260 will be set up with the third eccentric cam 261 to a known offset. The user can adjust the existing eccentric to the force needed to drive the filament. This may allow for an improvement in consistency of the force applied to leaf spring 256 from printer head 10 to printer head 10.

As noted above a receiver 158 seen in FIG. 6b is also provided in the feed system 14. The receiver 158 is an elongate member that guides the filament 22 between the feed hob 154 and the idle assembly 156, which may assist in preventing the filament 22 from rubbing against or becoming entangled in the feed hob 154 and the idle assembly 156.

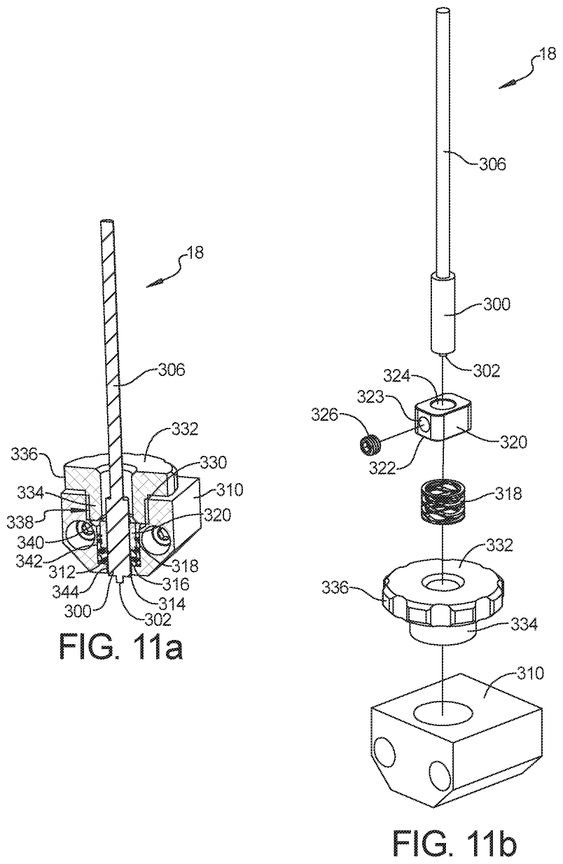

The printer head 10 also includes one or more sensors that determine the height of the z-axis plate 94 relative to the feed plate 112. FIG. 2, with further reference to FIGS. 11a and 11b, illustrate an aspect of a sensor assembly 18 including an electromechanical on/off position sensor 300, in this case a push button switch or a limit switch, wherein the switch is triggered by the z-axis plate assembly 16 contacting and activating the switch 302. In addition to a electromechanical on/off position sensor 300, or alternatively to a electromechanical position sensor 300, other linear position sensors, such as magnetic sensors or optical switches, may be used that continuously track the position of the z-axis plate 94 relative to the feed plate 112. Such sensors may include linear encoders, linear variable differential transformers, Hall Effect sensors, inductive sensors, piezo-electric transducers, etc. In particular aspects, a continuous position sensor 304 (seen in FIG. 2) is used in combination with the electromechanical position sensor 300. The electromechanical position sensor 300 includes a wire lead 306 that electrically couples the electromechanical position sensor 300 to the control system 400, see FIG. 13.

As illustrated, the sensor assembly 18 includes further a sensor bracket 310 that is coupled to the feed plate 112; however, it may be appreciated that in some variations of deployment, the sensor bracket 310 is coupled to the z-axis plate 94. The sensor bracket 310 includes an opening 312 defined therein through which the electromechanical position sensor 300 passes. At the bottom end 314 of the opening 312, a ledge 316 is present extending into the opening 312. On the ledge 316, a spring 318 is placed around the electromechanical position sensor 300. A retention block 320 rides upon the spring 318 and, in particular aspects, the spring 318 is inserted into a channel in the base 322 of the retention block 320, is coupled to the spring 318, or both.

The electromechanical position sensor 300 is inserted through a bore 324 in the retention block 320. The retention block 320 is secured to the sensor using a mechanical fastener 326 that engages both the electromechanical position sensor 300 and the retention block 320. In aspects, the mechanical fastener 326 is a set screw that includes threads that mate with the threads (not illustrated) in a bore 323 in the retention block 320 and applies a force against the electromechanical position sensor 300. In further aspects, the mechanical fastener 326 is fully received in the retention block 320, i.e., it does not protrude from the retention block 320, so that the retention block may ride freely within the opening 312 between the ledge 316 and the opposing, top end 330 of the opening 312.

Further, an adjustment knob 332 is engaged in the opening 312, such as by an interference fit of the base 334 of the adjustment knob 332 with the opening 312 or engaged in the opening 312 by mating threads located on the base 334 of the adjustment knob 332. The base 334 of the adjustment knob 332 abuts the retention block 320 and biases the retention block 320 and spring 318 against the ledge 316. By moving the adjustment knob 332 up and down, the position of the retention block 320 and sensor 300 relative to the z-axis plate 94 can be adjusted up or down. As illustrated, the adjustment knob 332 includes a grip portion 336 that, in the illustrated aspect, exhibits an outer diameter that is larger than the outer diameter of the base 334 and the end 314 of the opening 312. However, the adjustment knob 332 may alternatively exhibit a grip portion 336 that is the same as or smaller than the base 334 of the adjustment knob 332. In addition, while the adjustment knob grip portion 336 is illustrated as being generally cylindrical in shape, the adjustment knob grip portion 336 may exhibit other configurations, including polyhedron prism shapes, such as that of a hexagonal prism, an octagonal prism, etc.

It may be appreciated that as in the aspect illustrated the diameter of the opening 312 changes along the length of the opening 312, wherein the diameter of the opening 312 changes from the top end 330 to the bottom end 314. A first portion 338 of the opening 312 proximal to and at the top end 330 is larger in diameter and transitions to a smaller diameter in a second portion 342 of the opening 312 proximal to or at the middle 340 of the length of the opening and further transitions to yet a smaller diameter in a third portion 344 of the opening 312 defined by the ledge 316. In the transition region 340, the opening is frusto-conical in shape. However it may be appreciated, that alternatively, the opening 312 may exhibit the same diameter through the first and second portions 338, 342, or even exhibit the same diameter along the entire length of the opening through the first, second and third portions 338, 342 and 344.

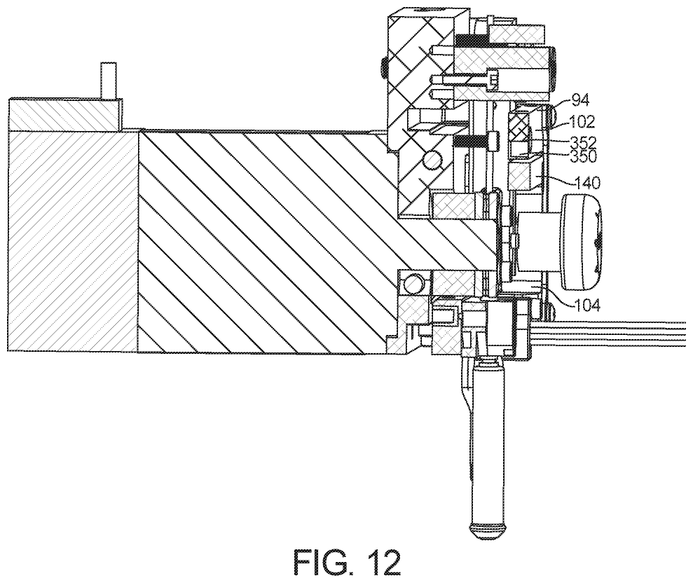

In aspects, as illustrated in FIG. 12, a force sensor 350 is placed on horizontal side wall 98 of the z-axis plate 94 or in the cross-bar 140 and arranged such that it measures the force between the cross-bar 140 and the z-axis plate. In the illustrated aspect, the force sensor 350 is placed within a pocket 352 in the horizontal side wall 98; it may alternatively be placed on the underside of the horizontal side wall 98. Alternatively, the force sensor 350 may be placed in a sensor assembly, as described above, in place of the electromechanical position sensor. In yet further aspects, the force sensor 350 is, e.g., a strain gauge, such as a button force sensor, or a capacitance sensor.

With reference again to FIG. 2, the 3D printer further includes a cooling system 460. As illustrated, the cooling system includes a cooling fan 462. Cooling fan speed is controlled by and measured by the control system 400. In aspects, the current supplied to the motor 466 is measured and optionally a rotary encoder 464 is used to determine fan speed. An external air supply 468 may optionally be provided.

The combination of the heating element, such as the heater coil 38, allows the provision a barrel 30 temperature in a range of 20° C. to 600° C., including all values and ranges therein such as 100° C. to 550° C. The cooling system 460 allows reduction of the barrel 30 temperatures at a rate of up to 60° C. per second, including all values and ranges from 0.5° C. per second to 60° C. per second.

FIG. 13 illustrates a control system 400, including hardware, firmware and software, for controlling the printer head 10. The control system 400 includes one or more processors 404, which is coupled to the various components 152, 14/16, 12 of the printer head 10, support table 20 and cooling system 460 through one or more communications links 406, such as a bus, electrical wire leads, or one or more wireless components (Wi-Fi, Bluetooth, etc.). Where more than one processor is present, the processors 404 perform distributed or parallel processing protocols and the processors 404 may include, for example, application specific integrated circuits, a programmable gate array include a field programmable gate array, a graphics processing unit, a physics processing unit, a digital-signal processor, or a front-end processor. The processors 404 are understood to be preprogrammed to execute code or instructions to perform, for example, operations, acts, tasks, functions, or steps coordinating with other devices and components to perform operations when needed.

As alluded to above, the drive motor 152, current sensor 164, torque sensor 166, and rotary encoder 168 are all electrically coupled, or alternatively may be wirelessly coupled, to the control system 400. In addition, the sensors, including the electromechanical on/off position sensor 300, continuous position sensor 304, and force sensor 350, associated with the feed system 14 and the z-axis plate assembly 16 are also electrically coupled, or alternatively may be wirelessly coupled, to the control system 400. Further, the temperature sensor 46 and heater coil 38, or other heating element, of the print nozzle 12 are also coupled to the control system 400. In addition, a continuous position sensor 418 associated with the support table and a step motor 420 associated with the support table 20 and moving the support table 20 up and down through the z-axis relative to the feed plate 112, such as a drive motor or a stepper motor. And also, the cooling system, including the motor 466 and optional rotary encoder 464, are coupled to the control system 400.

In various aspects, the sensors are utilized to measure melt flow and viscosity. In aspects, the drive motor 152 is programmed to feed the filament or other feedstock 22 at a given feed rate, e.g., cubic millimeters per second, which is based, e.g., on component 2 geometry, by applying an extrusion force on a filament. Further, a rotary encoder 168 is provided to measure the feed hob 154 or drive shaft 160 rotational speed. Alternatively, or additionally, an encoder may be used on the extrusion motor or on a filament when used as feedstock 22. The force to feed the filament 22 at that rate may be determined from the force and torque applied by the motor on the feed hob 154 (assuming no slip relative to the filament 22). Force and torque may be determined directly, or using a correlation based on the current supplied to the drive motor 152, a torque sensor on the drive wheel axis, a force measurement sensor on the nozzle clamp 64, or a pressure transducer inside the barrel 30.

For example, without being bound to these particular numbers, if the motor supplies 2 Nm of force per Amp and 2 Amps are being supplied to the motor 4 Nm of force is being applied. This measurement is then divided by the radius of the drive teeth plates 186, 188 to arrive at the force applied to the filament 22. In addition, the geometry of the barrel 30 and end tip 69 may be taken into account. From this measurement, shear viscosity, i.e., the resistance to shear flow, may be determined, given that shear stress (the force over the area) and shear strain (displacement) are known. Further, temperature is known as the temperature sensor 46 measures the barrel 30 temperature. Accordingly, flow profiles may be developed by the 3D printer for a given feedstock material based upon the above mentioned measurements and adjusting barrel temperature and feed rate of the filament.

Without being bound to any particular theory, as would be understood by a person having ordinary skill in the art, for many thermoplastic polymer materials or partially thermoplastic co-polymers (including some amount of cross-linking in the polymer chain) as well as some crosslinking polymer systems, as temperature increases in the barrel and the polymer temperature increases, the viscosity may decrease, at least up to a point where the material begins to thermally degrade. In addition, increases in the force applied to the filament or the rate at which force is applied to the filament may decrease viscosity, known as sheer thinning, up to the point where the filament is passing through the barrel to quickly to melt.

The combination of heat and force applied to the feedstock allows the feedstock 22 to flow through the print nozzle 12 and be deposited on the support table 20. However, drag on the feedstock 22 through the opening 32 of the barrel 30 and forces acting on the feedstock, such as pull on a filament as it is being fed from a filament cartridge, which may, e.g., cause the filament to retract, may affect the force determination made above. Accordingly, force detected at the force sensor 350 may be used to alter or adjust the force measurement determined above.

A method of depositing feedstock to form a three-dimensional component 2 (see FIG. 2) using the above described printer head 10 is also disclosed herein. The feedstock 22 is fed into a barrel 30. In the liquefier portion 40 of the barrel 30, the feedstock 22 is heated to reduce the viscosity of the feedstock 22 in combination with the extrusion force applied on the feedstock 22 to extrude the feedstock 22 onto the support table 20. The feedstock 22 is deposited in a plurality of sequential layers on the support table 20, each layer at least partially solidifying prior to the deposition of the next layer until a three-dimensional component 2 is formed.

In further aspects, where a filament 22 is employed as a feedstock, to feed the filament 22 into the barrel 30, the filament 22 is engaged by the drive teeth 198 of the feed hob 154; being biased against the feed hob 154 by the idle assembly 156. The drive motor 152 rotates the feed hob 154 and pulls the filament 22 and forces the filament 22 into the print nozzle 12 barrel 30. In the barrel 30, the filament 22 is heated at a temperature sufficient to reduce the viscosity of the filament 22. Due to the force applied to the filament 22 by the feed hob 154, the filament 22 may further undergo shear thinning as it exits the barrel 30, further reducing the viscosity. The filament 22 exits the print nozzle 12 and is deposited in a plurality of sequential layers on the support table 20, each layer at least partially solidifying prior to the deposition of the next layer until a three-dimensional component 2 is formed.

In aspects, the rate at which the feedstock 22 is fed into the print nozzle 12 is determined by the control system 400, which also measures the actual feedstock feed rate and adjusts motor current and torque to achieve the desired feed rate.

Accordingly, the shear thinning regime for a given polymer material system can be identified and mapped using the 3D printer disclosed herein, in addition to or alternatively to other rheological measurement methods. In aspects, heat is applied to the feedstock 22 by the liquefier 40 to achieve viscosity reduction into the shear-thinning regime for a given flow rate and temperature, thus allowing greater flow-rate for a given amount of extruder power. The temperature at the nozzle (T_{nozzle}) provided by the thermal couple 46, pressure at the nozzle (P_{nozzle}) derived from the current sensor 164 or torque sensor 166, and optionally temperature of the extrusion (Tₑₓₜ), which may be measured or derived from the nozzle temperature, are used to map viscous behavior and stay in shear-thinned regime. Two separate maps may be generated, one for achieving a viscosity in the shear thinning region, and the other for maintaining a viscosity in the shear thinning region. The control system 400 of the 3D printer is designed to operate under the shear-thinned regime (via T_{nozzle}, P_{nozzle}) by obtaining the extrusion speed and temperature set points for a predefined tool path and polymer, computing from pre-established calibration data the feed rate and temperatures needed to provide shear-thinning, then adjusting the tool path, if necessary.

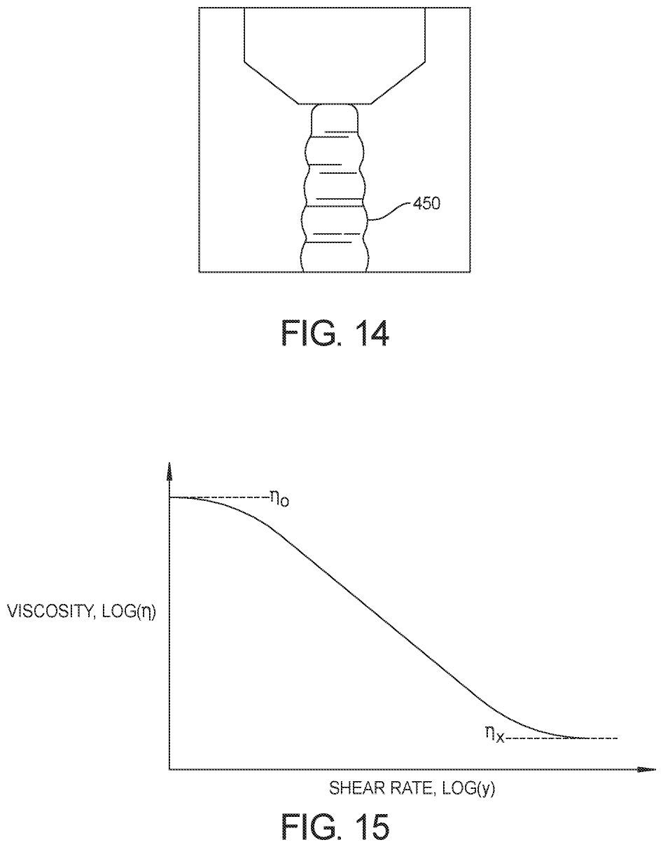

It was surprisingly discovered that when running at speeds beyond the capabilities of existing FFF and FDM printers, the print quality improves with speed. In addition, extrusion forces drop off significantly at a consistent and predictable point. As the speed is increased, a wavy or a beaded pattern on the extruded material 450 as shown in FIG. 14, which does not present a structural integrity issue with the printed 3D part. The wavy pattern, also referred to as chuddering, may be due to the release of pressurized/elastic melt by a rapid drop in port resistance due to shear-thinning (rapid reduction in viscosity) through the port. The chuddering could also be shark-skinning possibly stick-slip at the port exit. To avoid the wavy or beaded pattern, the feed rate of the printer may be reduced. As alluded to above, the following parameters may be adjusted individually or in combination to reduce or eliminate the amount of chuddering: lubricity, lubricants, material, material additives, exit flare, heating at the tip, etc. As noted above, The 3D printing system is designed to operate in a shear-thinned regime of the feedstock 22, in which the material exhibits a shear rate of >3000 1/s or greater, such as in the range of 3,000 to 10,000 1/s, including all values and ranges therein. The 3D printing system is designed to utilize relatively high torque, up to near 70 mm\hat{ }3/s with a 0.4 mm diameter nozzle opening, such as torque in the range of 50 mm\hat{ }3/s to 65 mm\hat{ }3/s with a 0.4 mm diameter nozzle opening, including all torque values and ranges therein. Degree of shear-thinned flow can be sensed by the amount of power required for a given feed rate measured by the encoder 168, which should be a direct correlation to W/mm\hat{ }3/s Extruder dynamics could be used to jump-start the shear-thinning process. Pre-stressing the cold material before heating may accelerate the transition to shear-thinning to increase extrusion rates. In further aspects, the melt may be shocked with pulsed force with a hi-performance extruder motor, wherein additional force may be applied in pulses. Resistance, also known as head loss, is understood as the difference between shear-thinned flow and Newtonian flow may allow greater gap between flow and no-flow scenarios, thus effectively becoming a means to limit ooze/bleed when off. This may require the reduction in barrel 30 temperature by the cooling system 460.

To start and stop printing, known FDM printers retract the filament to turn off extrusion when required. The retraction of the filament actually reverses the extrusion flow. Starting extrusion flow back up after a retraction of the filament takes time to stabilize, resulting in reduction of the quality of the extruded material on restart. In the process described herein, operating in in the shear-thinned region, the printing process may be paused or stopped simply by reducing the force/pressure exerted on the extrusion material by the drive motor 152. The process herein allows the start and stop of the printing process to be quicker than that of what is understood to be exhibited by known 3D printing process.

When shear-thinning polymers are melted and put under significant shear strain, their viscosity often falls. The extruder drive motor 152 effort (force) may then drop at higher extrusion speeds and feed rates because the melt is entering a thinned regime at the discharge end 36 of the barrel 30 and/or as the extrudate is mashed under the edge of the barrel 30. The present process operating in the shear thinning regime may enable the use of lower melt temperatures. Reduced temperature enables reduced thermal distortion of printed parts.

Travel of the print head 12 in the x,y direction is contemplated to reach up to 2000 mm/s, including all values and ranges from 1 to 2000 mm/s. with the acceleration and power reach this speed relatively consistently. The starting requirements include many forward-looking performance requirements, such as: a 12× increase in force on extruder; 2 orders of magnitude improvement in extruder responsiveness; 3× the acceleration and top speed; relatively fast reacting and accurate temperature control; and force/pressure feedback from barrel 30 as measured by the drive motor 152 torque.

According to the Hagen-Poisseuille law for laminar flow of a viscous fluid in a pipe (opening 32 of the barrel 30 at the discharge end 36): volumetric flow is linear with driving pressure, i.e., torque; increasing with the fourth power of the radius of the opening 32 of the barrel 30 at the discharge end 36, inverse with viscosity, inverse with pipe length; and the pressure for a given rate of flow is linear with length, flow rate, and viscosity and inverse with the fourth power of diameter of the opening 32 of the barrel 30 at the discharge end 36. Therefore, if the instantaneous viscosity of the flow in the opening 32 of the barrel 30 at the discharge end 36 is driven down by two decades, the pressure required to support that rate of flow should decrease by the same two decades.

Hagen-Poiseuille is understood to be represented by the following equation: P=k*Q*mu, wherein P is pressure, k is a geometry constant, Q is volume flow rate, and mu is viscosity. From this equation, it is understood that pressure decreases as viscosity decreases. This law is applicable to laminar, incompressible, and Newtonian flow. At low extrusion rates, the flow and viscosity of the shear thinned feedstock 22 may approach that of Newtonian flow. Referring to FIG. 15, which illustrates the effect of shear rate on viscosity of shear thinning materials, it is desirable to operate in a regime to the right of the curve where viscosity is relatively low, approaching Newtonian behavior, allowing relatively high flow rates per Hagen-Poiseuille.

The viscosity of the melted feedstock 22 at volumetric flow rates of 10 mm\hat{ }3/s to 100 mm\hat{ }3/s is enough to keep the Reynolds number relatively low, indicating laminar flow. As the material is sheared into the thinned-regime and the flow rate increases, so will the Reynolds number. Per the Darcy-Weisbach formulation for flow in a pipe, this may eventually lead to increasing back-pressure from boundary drag and turbulent flow effects, roughly with the square of the mean flow velocity. Darcy-Weisbach is understood to be represented by the following equation: P=K*v\hat{ }2 where K is a geometry and material property constant and v is the mean flow velocity.

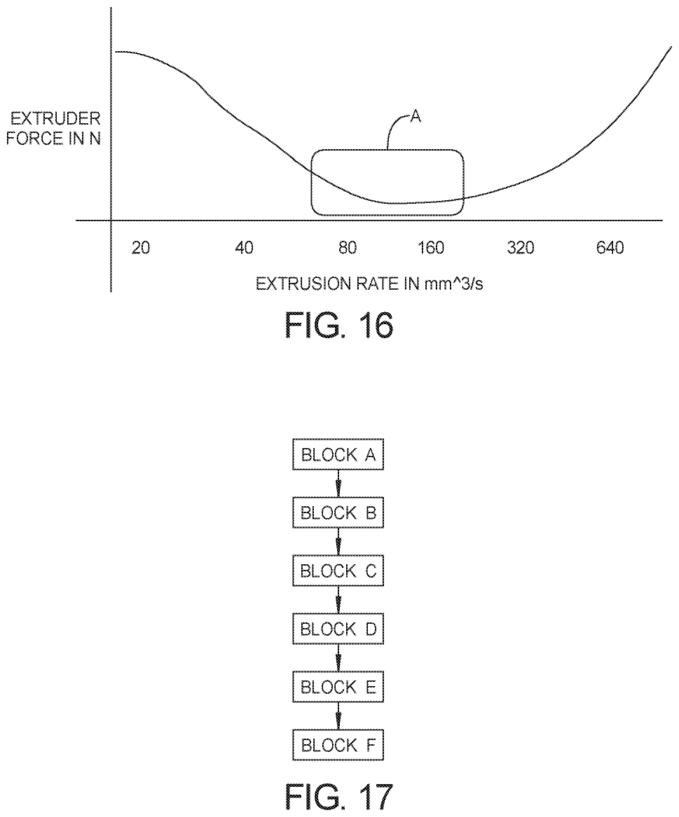

Superimposing Hagen-Poiseuille and Darcy-Weisbach, an extrusion force vs. flow rate plot as shown in FIG. 16 may be exhibited. In this plot, as extrusion rate increases, extruder force decreases, likely due to a decrease in viscosity due to thermal and shear thinning effects. However, as extrusion rate continues to increase, the extruder force begins to increase again. This may be due to less residence time in the barrel, preventing melting of the feedstock and increasing viscosity, as well as effects induced by the mean flow rate and increase in Reynolds number. The highlighted area A on the plot provides a desirable operating region where.

A reduction in required force was observed for extrusion of Polyethylene Terephthalate (PET) through an 0.4 mm opening 32 in the discharge end 36 of the barrel 30 from 20 N/mm\hat{ }3/s to 40 N/mm\hat{ }3/s. It was also observed (intermittent, out-of-control) ‘jetting’ of flow from an 0.4 mm opening 32 in the discharge end 36 of the barrel 30 under relatively high extrusion rates (˜60 mm\hat{ }3/s) which left a cavity behind the ejected material. This intermittent jetting may be a pressure build-up of compressed (visco-elastic) melt in front of the solidus (where the solid portion of the feedstock 22 and the melt portion of the feedstock 22 meet in the liquefier 40), heading for the discharge end 36 of the barrel 30, which is rapidly released (faster than the solidus is pushing down) by a large decrease in viscosity at the discharge end 36 of the barrel 30. This may then create a relatively low-pressure region where the low-viscosity melt just was, which fills with solidus—and the process repeats. One way to moderate this effect—expected as part of ramp-up to or ramp-down from a shear-thinned regime—is to create a larger volume of melt between the solidus and the port. This melt volume could become part of the geometry constants in the Hagen and Darcy equations, above.

The present disclosure provides a combination of 3D printer extruder hardware and control system 400 firmware run-time procedures to perform material flow calibration data sets, which are used to set the operating parameters for a given print job. The data collection step may either be performed before each print for individual printers, or may be performed at a separate time on separate 3D printers and the material processing conditions transferred digitally onto subsequent printer control system 400 and firmware modules. This combination of hardware and enabling software comprise a product solution specific to a printer platform that is designed to operate at significantly higher extrusion speeds in the range of up to 500 grams per hour, such as in the range of 1 gram per hour to 500 grams per hour including all values and ranges therein such as 200 grams per hour to 400 grams per hour because of data-driven operating conditions. It should be appreciated, however, that the density of the material may effect these numbers, thus the numbers given above are based on materials exhibiting a density of 1.15 g/cm\hat{ }3. Extrusion speeds and volumetric flow rates, as described herein, may be understood as the rate at which the feedstock 22 is extruded through the print nozzle 12. However, due to slowing at corners, slowing between layers, etc., the print speed or mass throughput rate during printing may be relatively less, such as 20 to 99 percent of the extrusion speed including all values and ranges therein such as 60 to 99 percent of the extrusion speed.

The extrusion process is enabled by three key elements: hardware on the extrusion printer head 10, rheological characterization procedure, and data analysis translation to control system 400 settings. The 3D printer hardware includes components often found in capillary-flow strain-controlled melt rheometers. A rheometer is understood as a precision instrument that contains the material of interest in a geometric configuration, controls the environment around it, and applies and measures wide ranges of stress, strain, and strain rate. This consists of at least a polymer liquefier and nozzle to establish polymer flow, an accurate strain (displacement) measurement system, and a stress (force) measurement system, also included in the 3D printers described herein. As noted above, a strain measurement system may include the encoder 168 on either the feed hob 154, or the drive shaft 160, or a direct filament encoder. When coupled with the geometry of the barrel 30, accurate strain and shear rate measurements may be calculated. The stress measurement system may include a current sensor 164, torque sensor on the extrusion motor 152, a torque sensor on the drive wheel axis, a force measurement sensor on the nozzle mount, or a pressure transducer inside the nozzle.

From the data gathered by the sensors, or acquired on separate hardware (other printers alone or in combination with data gathered on rheometers), extrusion mappings are developed and used to induce the transition in and out of the shear-thinned regime. The rheological characterization procedure includes performing material feed rate (shear rate) sweeps and recording the shear stress response of various polymer feedstock materials. Additional sweeps at various temperatures allows a master curve to be calculated for a given material system using time-temperature superposition. From this data, various control algorithms may be calculated to configure the printer firmware and optimize the material flow characteristics for maximum build rates.

A method of rheological characterization is shown in FIG. 17, and includes the steps of: referring to Block A, performing feedstock 22 feed rate (shear rate) sweeps of a polymer feedstock material by extruding a feedstock 22 through the print nozzle 12 at various extrusion forces to achieve a range of feed rates and deriving the feedstock 22 viscosity from encoder 168 and drive motor 152 torque measurements the for extrusion force applied for each feed rate; referring to Block B, recording the shear stress responses of the polymer feedstock 22 extruded through the barrel 30 at various barrel temperatures in a range of temperatures by extruding the feedstock 22 through the print nozzle 12 barrel 30 at various barrel 30 temperature settings and at one or more extrusion forces and deriving a feedstock 22 viscosity from encoder 168 and drive motor 152 torque measurements for each temperature setting; referring to Block C, calculating a master viscosity curve for a given feedstock 22 using time-temperature superposition; referring to Block D, calculating control algorithms from the master curve; referring to Block E, configuring the printer control system 400 using the calculated control algorithms; and referring to Block F, optimizing the feedstock 22 flow characteristics for maximum build rates, which may be understood herein as the fastest available build rate for that particular material at the feed rate and temperature conditions tested. It may be appreciated that in characterizing the material, corrections may be made to the rheological curves as understood by a person having skill in the art, such corrections may include those applied in capillary rheometry. Beyond the performance necessary to create the conditions for shear-thinning, the feedback required to monitor it, the print nozzle 12 and heater element/heater coil 38 are responsive to maintain and control the process herein.

The combination of variables is arranged to create flow that operates in the shear-thinned regime of the feedstocks 22 described above, including but not limited to the following variables: material density in the range of 0.8 g/cm\hat{ }3 to 1.6 g/cm\hat{ }3, including all values and ranges therein; material melt viscosity when exiting the print nozzle 12 in the range of <10\hat{ }4 Pa*s, including all values and ranges therein; extruder force in the range of 1 N to 100 N, including all values and ranges therein, derived from drive motor torque; heater coil 38 power in the range of 3 W to 100 W, including all values and ranges therein; barrel 30 temperature in the range of 20° C. to 600° C., including all values and ranges therein; end tip 69 shape, including all values and ranges therein; end tip 69 diameter in the range of 0.25 to 5 mm, including all values and ranges therein; end tip 69 length in the range of 0.2 to 5 mm, including all values and ranges therein; barrel 30 opening 32 shape; barrel 30 opening 32 diameter in the range of 1 mm to 10 mm, including all values and ranges therein; and barrel 30 opening 32 length in the range of 1 to 150 mm, including all values and ranges therein. When the correct combination of variables is implemented, the 3D printer 10 can operate in a regime where extruder force per unit volumetric flow (N/mm\hat{ }3/s) is in a range below 2.4e-4 N/mm\hat{ }3/s, which is understood to be well below the current practice in the art. It may be appreciated that the above parameters and ranges may be used to select parameters for calibrating the 3D printer head 10.

The disclosure also provides for a sensing system and computational algorithms which determine if the system is extruding in an appropriately shear-thinned regime, and makes corrections to the above variables to maintain shear-thinned extrusion, including recommendations for hardware changes (port size).

In aspects, the operating range may be defined by assuming the flow resistance increases with (roughly square of) flow velocity for any fluid. It is desirable to be in the polymer melt flow regime where dynamic viscosity is reduced to about 1/10th of the viscosity of viscosities that are understood to be exhibited by FFF/FDM printers, which are also understood to run at ˜35 mm\hat{ }3/s or 150 grams per hour or less. Again, it may be appreciated that the print mass throughput rate, i.e., the actual throughput during printing may be significantly lower.

It may be appreciated that the barrel 30 temperature may be perturbed by the variations in flow rate. In order to maintain the operation in the shear-thinned regime the speed profile defined by the toolpath is known by the control algorithm and is used to optimize the control variables set points.

It may further be appreciated that the shear thinned regime is understood to be highly dependent on geometry variables in the barrel 30. For a relatively smaller diameter barrel 30 opening 32, the amount of shearing is higher for a given flow rate than for a relatively larger diameter barrel 30 opening. As such, there will be a shift in the entire regime depending on the barrel 30 opening 32 size. Provided is a system that receives, either by user input or by automatic calibration, a nominal flow rate for shear-thinned operation, then proceeds to operate in that regime. There may be some sort of ‘ramp’ through more viscous flow. Means to ramp quickly through this flow, and sense when it is into the shear-thinned regime is also provided.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method of printing with a 3D printer, comprising:
feeding a feedstock into a barrel by applying a first extrusion force;
heating the feedstock in the barrel at a first temperature; and
depositing the melted feedstock onto a support table, wherein the first extrusion force and first temperature are selected to cause the feedstock to undergo shear thinning.

2. The method of claim 1, further comprising melting the feedstock in a liquefier portion of the barrel, wherein a temperature of the barrel is in the range of 20° C. to 600° C.

3. The method of claim 1, wherein the feedstock is a filament and the method further comprises engaging the filament with a rotatable feed hob coupled to a drive motor to feed the filament into the barrel.

4. The method of claim 1, further comprising adjusting the first temperature and the first extrusion force to maintain shear thinning of the feedstock while printing.

5. The method of claim 3, further comprising measuring a torque applied to a drive shaft, wherein the rotatable feed hob is coupled to the drive motor by the drive shaft.

6. The method of claim 5, further comprising measuring torque by measuring a current supplied to the drive motor.

7. The method of claim 1, further comprising selecting the first extrusion force and the first temperature from a master viscosity curve, wherein the master viscosity curve is calculated from a plurality of viscosity measurements derived from a plurality of sensor measurements taken at various feed rates and various barrel temperatures.

8. The method of claim 7, wherein the sensor measurements include an extrusion force measurement, an encoder measurement, and a temperature sensor measurement.

9. The method of claim 1, further comprising reducing the first temperature of the barrel to a second temperature at a rate in the range of 0.5° C. per second to 60° C. per second.

10. The method of claim 1, further comprising stopping deposition of the melted feedstock by reducing the first extrusion force.

11. A three-dimensional printer, comprising:
a control system;
a barrel including a heating element electrically coupled to the control system, wherein the control system is configured to select a barrel temperature and to heat the barrel with the heating element;
a feed system coupled to the control system configured to supply a feedstock to the barrel, wherein the control system is configured to select an extrusion force applied to the feedstock by the feed system; and
wherein the control system is configured to select a barrel temperature and an extrusion force that causes the feedstock to undergo shear thinning during printing.

12. The three-dimensional printer of claim 11, wherein the feed system comprises: a drive motor including a drive shaft; a feed hob coupled to the drive shaft and configured to engage the feedstock; a torque sensor electrically coupled to the control system configured to measure extrusion force applied by the drive motor; and an encoder electrically coupled to the control system configured to measure a speed of the drive shaft.

13. The three-dimensional printer of claim 12, wherein a temperature sensor is affixed to the barrel and coupled to the control system.

14. The three-dimensional printer of claim 13, wherein the control system is configured to calculate a master curve based on a plurality of viscosity measurements derived from extruding the feedstock at various feed rates, wherein the various feed rates are measured by the encoder, temperatures measured by the temperature sensor; and the extrusion force for each feed rate and each temperature measured by the torque sensor.

15. The three-dimensional printer of claim 14, wherein the torque sensor is a current sensor configured to measure a current applied to the drive motor.

16. The three-dimensional printer of claim 11, further comprising a cooling system.

17. A method of calibrating a three-dimensional printer, comprising:
performing a feedstock feed rate sweep by extruding a feedstock material through a printer nozzle at various extrusion forces and barrel temperatures to achieve a range of feed rates;
deriving a feedstock viscosity at each feed rate and barrel temperature;
calculating a master viscosity curve for the feedstock from the feedstock viscosity derived at each feed rate and each barrel temperature; and
selecting a feed rate and temperature range for the feedstock for providing a maximum feedstock throughput rate.

18. The method of claim 17, wherein each feed rate is measured by an encoder configured to measure the rotational rate of a drive shaft.

19. The method of claim 18, wherein each extrusion force is measured by a torque sensor associated with a drive motor coupled to the drive shaft.

20. The method of claim 17, wherein each barrel temperature is measured by a temperature sensor mounted to the barrel.
